(19) United States
(12) Patent Application Publication
(10) Pub. No.: US 2004/0214978 A1
(43) Pub. Date: Oct. 28, 2004

(54) Moisture-curing, hot-melt polyurethane adhesive

(76) Inventors: Michael L. Rosin, Milford, NH (US); Francis G. Willwerth III, Acton, MA (US); Nathan A. Theriault, Nashua, NH (US)

Correspondence Address: WIGGIN AND DANA LLP, ATTENTION: PATENT DOCKETING, ONE CENTURY TOWER, P.O. BOX 1832, NEW HAVEN, CT, 06508-1832, US

(21) Appl. No.: 10/420,392

(22) Filed: Apr. 22, 2003

(51) Int. Cl. C08G 18/00

(52) U.S. Cl. 528/44

(57) ABSTRACT

A moisture-curing hot-melt polyurethane adhesive composition, the composition being the reaction product of reactants comprising a hydroxyl-containing component, an aromatic chain extender, a crystalline polyester, an amorphous polyester and an isocyanate, the adhesive composition exhibiting a green peel strength of at least 5 pli @ 1 minute and 12 pli @ 5 minutes when tested in accordance with Test QC-0220 and a creep resistance of less than 7 millimeters when tested in accordance with the Creep test.

### BACKGROUND OF THE INVENTION

1. Field of the Invention

The present invention relates to a selected moisture-curing, hot-melt polyurethane adhesive, its production and its use in footwear construction. In particular, this invention relates to a selected uncured moisture-curing, hot-melt polyurethane adhesive composition having at least one aromatic chain extender as a component.

2. Brief Description of Art

A moisture-curing, polyurethane hot-melt adhesive is an adhesive largely free of solvents and having urethane groups. The adhesive is solid at room temperature and is applied to a substrate or substrates in the form of a melt. It physically binds not only by cooling but also by chemical reaction of still present isocyanate groups with water. It is only subsequent to such chemical curing with the increase in molecular size that the adhesive receives its final characteristics.

Hot-melt adhesives are attractive from the viewpoint of speed of set up and ease of application. Hot-melt adhesives are widely used in the footwear industry. One important requirement in providing satisfactory adhesive bonds is that the applied adhesive composition must have sufficient fluidity to enable it to adequately wet the substrate to which it is applied. In addition, the composition should also effect at least some penetration of fibrous substrates. Further, it is also important that the composition develop a tough solid bond. The aforementioned requirements are particularly important in adhesively bonding shoe soles to shoe uppers where the finished product is subject to variations of stress under different conditions of use.

The desirable characteristics for an adhesive composition for application for sole attaching purposes include the following: The adhesive composition should be capable of application in fluid form at a temperature which is sufficiently low such that the shoemaking materials are not adversely effected. The adhesive composition should have at such application temperatures, good heat resistance, viscosity and flow characteristics which enable it to properly wet surfaces to which it is applied and preferably also to penetrate fibrous materials, for example, synthetic materials to establish good initial adhesive bonds to the materials. Coatings of the adhesive on the materials should have good green strength, creep resistance, and harden adequately within a few minutes to provide at least a non-tacky surface and preferably a solid, form-retaining, non-tacky coating on the material to the extent that either soles or shoe uppers or both coated with the adhesive compositions may be handled and stored when cooled without sticking together and without significantly disturbing the applied layers of adhesive compositions. It is also desirable that the adhesive union between the sole and shoe upper should initially be sufficiently strong to avoid springing of the sole edges from the shoe upper during handling and storage immediately at the sole pressing, i.e., have good green strength and creep resistance and should be or become adequately cured to withstand normal conditions of use of the shoe.

Particularly, when using a moisture-curable hot-melt polyurethane adhesive, it is desirable that coatings of the adhesive composition on the shoe quickly cure after application to bring about conversion of the adhesive to a tough solid condition. Further, when using a moisture-curable, hot-melt, polyurethane composition, curing should occur at normal ambient conditions of sole storage, (i.e., approximately between 15° C. and 30° C. and relative humidity of not less than approximately 10%). Lastly, the cured adhesive composition should have good flexibility at low temperatures and provide a strong bond to a variety of materials, such as those employed in the shoe industry.

Many of the foregoing drawbacks were discussed and were to a considerable extent overcome by the teachings of U.S. Pat. Nos. 5,599,895 and 6,136,136.

However, several drawbacks still have not been sufficiently overcome by those adhesive products taught by these patents. Specifically, these patented adhesives do not have high enough green strength along with sufficient creep resistance to allow the shoe sole to be attached to the shoe upper without distortion. Furthermore, these patented adhesives do not act in a commercially acceptable timeframe. And further, these patented adhesives do not perform adequately with vinyl substrates common in the shoe industry. Until the present invention, polyurethane adhesives have not possessed sufficient green strength, along with sufficient creep resistance, to allow shoes to be assembled in a timely manner for all types of substrates including vinyl without numerous defects, high level re-work or rejects. The present invention provides a solution for overcoming these recognized problems.

The following other references may be also relevant to the present invention:

U.S. Pat. No. 5,115,073; Moisture Curing Hot Melt Adhesives, Dr. H. F. Huber and Dr. H.-W. Losensley, 16th Munich Adhesive and Finishing Seminar (1991)—(Separate Print 45.07.162e); Hot Urethanes, Renee von Schijndel and Eric Appleman, Adhesive Age (December 2001); The Building Block System for Moisture Curable Hot Melt Adhesives and Sealants (Degussa Corporation Technical Bulletin); Rucoflex Product Bulletin (Ruco Polymer Technical Bulletins); and The Capa Range of Products (Solvay Caprotactones, Cheshire, UK Technical Bulletin).

### BRIEF SUMMARY OF THE INVENTION

Accordingly, one aspect of the present invention is directed to an uncured, moisture-curing, hot-melt polyurethane adhesive composition, the uncured composition having an aromatic chain extender component, the uncured adhesive composition exhibiting a green peel strength of at least 5 pounds per linear inch (pli) at 1 minute and at least 12 pounds per linear inch (pli) at 5 minutes when measured in accordance with Test QC-0220 and a creep resistance of less than 7 millimeters, when measured in accordance with the Creep Test.

Another aspect of the present invention is directed to a method of producing a moisture-curing hot-melt polyurethane adhesive composition comprising:

(a) heating (1) a hydroxyl-containing component selected from the group consisting of one or more polylactones, one or more polyether polyols, or combinations thereof; (2) at least one crystalline polyester, (3) at least one amorphous polyester and (4) at least one aromatic chain extender to form a mixture; and

(b) reacting (5) a polyisocyanate with the mixture to produce an uncured moisture-curing hot-melt polyurethane adhesive composition, the uncured adhesive composition exhibiting a green peel strength of at least 5 pounds per linear inch (pli) at 1 minute and at least 12 pounds per linear inch (pli) at 5 minutes when tested in accordance with Test QC-0220 and a creep resistance of less than 7 millimeters when measured in accordance with the Creep Test.

Still another aspect of the present invention is directed to a method for bonding a first substrate to a second substrate comprising:

(a) optionally, treating at least a portion of the first substrate to form a treated first substrate;

(b) heating an adhesive-forming composition, said composition containing an aromatic chain extender to form a molten adhesive composition;

(c) coating at least a portion of the treated first substrate with the molten adhesive composition to form a coated substrate;

(d) optionally, heating the coated substrate; and

(e) contacting the coated first substrate with a second substrate to bond the first substrate to the second substrate.

### DETAILED DESCRIPTION OF THE INVENTION

As stated above, the present invention is broadly directed to an uncured, moisture-curing, hot-melt polyurethane adhesive compositions that have at least one aromatic chain extender as a component.

The term “moisture-curing” as used in the present specification and claims in conjunction with polyurethane adhesive compositions means that those compositions at least partially cure into an effective adhesive composition by the reaction of moisture (e.g., water in the atmosphere or in the substrate) with isocyanate groups in the uncured adhesive composition. The present invention encompasses the use of any suitable conditions that may effect this curing reaction.

The term “hot-melt” as used in the present specification and claims in conjunction with polyurethane adhesive compositions means any composition that is solid at normal ambient temperatures, but may be heated into a molten state (a melt) before application onto one or more substrates that are to be bound together. The present invention encompasses polyurethane adhesive compositions that are made by any suitable hot-melt techniques.

The aromatic chain extender is an aromatic moiety which functions to increase the tensile strength and retention of strength at elevated temperatures. Such retention of strength is responsible for the increased green strength after the adhesive is heated to form a bond. The bond line will maintain significant heat after activation and the aromatic chain extender yields higher strength at elevated temperatures thus exhibiting improved green strength.

Preferably, the aromatic chain extenders are selected from the group consisting of aromatic ethoxylated or propoxylated diols or ethoxylated or propoxylated bisphenyl A or F derivatives, hindered aromatic diamines or secondary aromatic diamines. Preferred components include the following:

hydroquinone bis(2-hydroxyethyl) ether (HQEE)(CAS# 104-38-1) hydroquinone bis(2-hydroxypropyl) ether

resorcinol bis(2-hydroxyethyl) ether (HER-HP)(CAS# 103-40-9) resorcinol bis(2-hydroxypropyl) ether

bisphenol A ethoxylated (CAS#32492-61-8)

bisphenol A propoxylated (CAS# 37353-75-6)

bisphenol F ethoxylated

bisphenol F propoxylated

4,4′-bis(sec-butylamino) diphenylmethane (Unilink 4200)(CAS# 5285-60-9)

N,N′-di-sec-butyl-p-phenylenediamine (Unilink 4100)(CAS# 101-96-2)

N,N′-bis-(1,4-dimethylpentyl)-p-phenylenediamine (Unilink 7100)(CAS# 3081-1409)

4,4′-methylenebis(2-chloroaniline)(CAS# 106246-33-7)

4,4′-methylenebis(3-chloro-2,6-diethylaniline)(CAS# 101-14-4)

3,5-di(methylthio)toluenediamine(CAS# 106264-79-3)

3,5-diethyltoluene-2,4-diamine (CAS# 68479-98-1)

The most preferred aromatic chain extenders include seconding aromatic diamines, such as Unilink 4200, available from UOP, or ethoxylated aromatic diols such as a hydroquinone di(beta-hydroxyethyl)ether such as PolyG HQEE, available from Arch Chemicals, Inc. or a resorcinol di(beta-hydroxyethyl)ether such as HER-HP from Indspec Chemical Corp. Preferably, the invention includes a moisture-curing, hot-melt polyurethane adhesive composition that is a reaction product of reactants comprising a hydroxyl-containing component selected from the group consisting of one or more polylactones, one or more polyether polyols, or combinations thereof, in an amount of from about 10% by weight to about 50% by weight; an aromatic chain extender in an amount of from about 1% by weight to about 15% by weight; a crystalline polyester in an amount of from about 5% by weight to about 30% by weight; an amorphous polyester in an amount of from about 10% by weight to about 50% by weight; and a polyisocyanate in an amount from about 10% by weight to about 40% by weight, based on the total weight of the adhesive composition. The adhesive composition exhibits a minimum green peel strength of 5 pli @ 1 min. and 12 pli @ 5 mins. when tested in accordance with Test QC-0220, a green strength test described herein, and preferably also has an adhesive strength great enough to tear the SBR (styrene/butadiene/rubber) substrate when left overnight at room temperature and 50% R.H (relative humidity). The viscosity of the adhesive is about 15,000±7,500 cps when tested @ 350° F. using a Brookfield Thermosel Model DV-E viscometer using a speed of 5 rpm and a #27 spindle. Also, the adhesive compositions of the present invention exhibit a creep resistance level below about 7 millimeters when measured according to the Creep Test, which is described herein.

The green strength and adhesive strength of the adhesive compositions were the result of the reacting the hydroxyl-containing component, aromatic chain extender and the polyesters with the polyisocyanate in the above specified amounts. Most significantly, it was discovered that reacting the hydroxyl-containing component, aromatic chain extender, polyesters with the polyisocyanate in the above specified weight ranges may effect the production of the adhesive compositions exhibiting the above characteristics, namely a green peel strength of 5 pli @ 1 min. when tested in accordance with Test QC-0220.

In one aspect of the invention, the polylactones are selected from the group consisting of low molecular weight polylactones. A low molecular weight polylactone refers to a polylactone comprised of caprolactone and short chain glycol and having a molecular weight of between 250 to about 500.

The polylactone component from which the adhesive composition is formed is preferably liquid @ 30° C.

Polyethers are understood to comprise a polymer having 20H groups and preferably include those of the general formula HO(—R—O)ₘH, wherein R is a hydrocarbon residue having from 2 to 4 carbon atoms. Similarly, polyether copolymers including both block copolymers and random copolymers may be used. Suitable polyethers include polyethylene glycol, polytetramethylene glycol and poly(oxypropylene) glycol. It is contemplated that one type of polyether or combinations of different polyethers may be employed in the production of the adhesives compounds. Preferably, they have an average molecular weight (M_{w}) between about 250 and 600 as determined by end-group analysis.

Crystalline polyesters are solid polyesters at room temperature with melting points between about 40° C. to about 125° C. with the polyesters or resulting polyurethanes having glass transition temperatures below 0° C. Preferred materials are manufactured by Degussa and designated as the Dynacoll 7300 series of copolyesters. Similar polyesters are manufactured by Ruco Polymers and are designated as Rucoflex polyesters.

Amorphous polyesters are solid materials with glass transition temperatures above 0° C. Preferred materials are manufactured by Degussa and are designated as the Dynacoll 7100 series of copolyesters. Other preferred amorphous polyesters are manufactured by Ruco Polymers and are designated as Rucoflex polyesters.

The polyisocyanate component from which the adhesive composition is formed can include aromatic polyisocyanates, such as 4,4′-diphenylmethane diisocyanate, 2,4′-diphenylmethane diisocyanate and mixtures thereof, toluene diisocyanate, m-tetramethylxylene diisocyanate: aliphatic isocyanates, such as 1,6 hexamethylene diisocyanate, (2,2,4 and 2,4,4)-trimethylhexamethylene diisocyanate; cycloaliphatic isocyanates, such as 3-isocyanatomethyl-3,5,5-trimethylcyclohexyl isocyanate and dicyclohexylmethane 4,4′-diisocyanate.

In yet another aspect of the invention, the adhesive composition is a reaction product of reactants comprising a low molecular weight caprolactone in an amount of about 26.6% by weight, bis-(hydroxyethyl) ether of resorcinol (HER-HP) in an amount of about 4.0% by weight, a crystalline polyester in an amount of about 6.4% by weight, an amorphous polyester in an amount of about 32.0% by weight and a polyisocyanate in an amount of about 31.0% by weight, based on the total weight of the adhesive composition.

In another preferred aspect of the invention, the adhesive composition is a reaction product of reactants comprising a low molecular weight caprolactone in an amount of about 27.0% by weight, bis-(hydroxyethyl) ether of hydroquinone (HQEE) in an amount of about 4.0% by weight, a crystalline polyester in an amount of about 6.4% by weight, an amorphous polyester in an amount of about 32.0% by weight and a polyisocyanate in an amount of about 30.6% by weight, based on the total weight of the adhesive composition.

In yet another preferred aspect of the invention, the adhesive composition is a reaction product of reactants comprising a low molecular weight caprolactone in an amount of about 26% by weight, bis-(hydroxyethyl) ether of both resorcinol (HER-HP) and hydroquinone (HQEE) in an amount of about 4.0% by weight, a crystalline polyester in an amount of about 7.0% by weight, an amorphous polyester in an amount of about 32.0% by weight and a polyisocyanate in an amount of about 31.0% by weight, based on the total weight of the adhesive composition.

In another preferred aspect of the invention, the adhesive composition is a reaction product of reactants comprising a low molecular weight caprolactone in an amount of about 25.0% weight, a crystalline polyester in an amount of about 6.0% weight, an amorphous polyester in an amount of about 33.0% weight, an aromatic chain extender in an amount of about 6.0% weight and a diisocyanate in an amount of about 30.0% weight, based on the total weight of the adhesive composition.

In yet another aspect of the invention, the adhesive composition is a reactant product of reactants comprising a low molecular weight caprolactone, a secondary aromatic diamine, and an isocyanate as well as a crystalline polyester and an amorphous polyester.

The adhesive compositions of the invention may further include fillers, tackifiers, U.V. stabilizers, fluorescent whiteners, defoamers, pigments, wetting agents and surfactants, viscosity-modifying agents, and antioxidants, moisture-scavengers and the like.

The adhesive composition can have a ratio of reactive NCO groups to reactive OH groups from about 1.1/1.0 to about 2.0/1.0, preferably about 1.3-1.5/1.0.

The preparation of the adhesive composition can include the use of catalysts, e.g., dibutyltin dilaurate or dibutyltin dilaurylmercaptide, which may be present in the adhesive composition in an amount of from about 0.001% by weight to about 0.1% by weight, preferably about 0.01% by weight, based upon the total weight of the composition.

In addition, the preparation of the adhesive composition can include the use of stabilizers, e.g., benzoyl chloride, phosphoric acid, acetic acid and p-toluenesulfonyl isocyanate or combinations thereof. In one aspect, 0.001% to 0.01% of H₃PO₄ (85%) by weight, preferably about 0.0018% by weight, can be present in the adhesive composition based upon the total weight of the composition. In addition to phosphoric acid, 0.01% to 0.5% of p-toluenesulfonyl isocyanate, preferably about 0.10% by weight, can be present in the adhesive composition based upon the total weight of the composition.

The invention also includes a method of producing a polyurethane adhesive composition comprising heating a hydroxyl-containing component, a crystalline polyester, an amorphous polyester and an aromatic chain extender to form a mixture and reacting a polyisocyanate with the mixture.

In another preferred aspect, the invention includes a method of bonding a first substrate to a second substrate. The method comprises optionally treating a first substrate by roughing, priming, chlorinating, solvent washing, and the like, the first substrate. The adhesive composition is heated to form a molten adhesive and the molten adhesive is coated to the first substrate to form a coated substrate. The coated substrate is then optionally heated and then contacted to a second substrate, e.g., by pressing, to bond the first substrate to the second substrate. In one aspect of the invention, the first substrate is a shoe sole and the second substrate is a shoe upper. In another aspect of the invention, the first substrate is a shoe upper and the second substrate is a shoe sole. The shoe uppers can be constructed from leather or synthetic fabrics and the sole can be constructed from leather, rubber, or synthetic materials, such as thermoplastics.

In one preferred aspect of the invention, the bonded first and second substrate forms an article of footwear.

In yet another preferred aspect, the article of footwear comprises an upper and sole bonded together with an adhesive comprising the reaction product of reactants including a polylactone in an amount within the range of between about 50% to 10% by weight, an aromatic chain extender in an amount within the range of between about 15.0% to 1.0% by weight, a crystalline polyester in an amount within the range of between about 30% to 5% by weight, an amorphous polyester in an amount within the range of between about 50% to 10% by weight and an isocyanate present in an amount within the range of between about 40% to 10% by weight, based on the total weight of the composition. The adhesive composition used to bond the upper and the sole exhibits a green peel strength of at least 5 pli @ 1 minute and 12 pli @ 5 minutes when tested in accordance with QC-0220.

In an alternative preferred embodiment of the invention, the adhesive used to bond the upper and the sole of the footwear article is a composition being the reaction product of reactants comprising a polyether in an amount within the range of between about 50% to 10% by weight, an aromatic chain extender in an amount within the range of between about 15.0% to 1.0% by weight, a crystalline polyester in an amount within the range of between about 30% to 5% by weight, an amorphous polyester in an amount within the range of between about 50% to 10% by weight and an isocyanate present in an amount within the range of between about 40% to 10% by weight, based on the total weight of the composition. The adhesive composition exhibits a green peel strength of at least 5 pli @ 1 minute and 12 pli @ 5 minutes when tested in accordance with QC-0220.

Besides those aspects of the present invention drawn to bonding a first and second substrate together (e.g., shoe upper and a sole) by applying or coating the adhesive composition of the present invention to a surface of one of the two substrates and then contacting (e.g., pressing) the other substrate to that coated substrate to bond the substrates together, the present invention is also directed to other bonding techniques. For example, the adhesive of the present invention may be applied or coated to the surface of both substrates before they are contacted and bound together. Alternatively, the adhesive of the present invention may be applied to one substrate while another conventional adhesive composition may be applied to the other substrate before contacting and bonding together. Still further, the adhesive composition of the present invention may be applied or coated to the surface of one substrate along with another adhesive composition and then that coated substrate is contacted and bound together to a second substrate.

The present invention is further described in detail by means of the following Examples and Comparisons. All parts and percentages are by weight and all temperatures are degrees Celsius unless explicitly stated otherwise.

The present Examples and Comparisons are prepared using the following chemical ingredients:

¹Rucoflex™ XS-6012P-22 amorphous polyester with an OH# of 20.0 and an acid value of 2.0. A molecular weight of ˜5,000 and a glass transition temperature of ˜30° C. and a viscosity of 2900 cps. @ 200° C. A product of Ruco Polymers.

²Rucoflex™S-1074-30 a crystalline hydroxyl terminated polyester with an OH# of ˜30.0 and an acid value of #2.0. A molecular weight of 3,500, a melting point of ˜65° C. and a viscosity of ˜2,000 cps @100° C. A product of Ruco Polymers.

³Capa™ 2043, a 400 molecular weight polyester diol derived from ε-caprolactone and 1,4 butanediol with a melting point of 0-10° C., an OH# 280 mg KOH/g and an acid value of <0.5 mg KOH/g. A Product of Solvay Interox Inc.

⁴Unilink™ 4200 a secondary aromatic diamine CAS No. 5285-60-9, a product of UOP LLC of Des Plaines, Ill.

⁵Irganox™ B225, a 1 to 1 by weight mixture of tetrakis [methylene(3,5-di-tetr-butyl-4-hydroxyhydrocinnamate)] methane CAS No. 6683-19-8 and tris(2,4-di-tert-butylphenyl) phosphite CAS No. 31570-04-4, a product of Ciba-Geigy.

⁶Mondur™ M (Fused or Flaked), 4,4′-diphenylmethane diisocyanate CAS No. 101-68-8, a product of Bayer Corp.

⁷Fomrez™ UL-1, alkyltin mercaptide, a product of Witco Corporation.

⁸p-Toluenesulfonyl isocyanate CAS No. 4083-64-1, a moisture scavenger, a product of of VanDeMark Inc., Lockport, N.Y.

⁹PolyG®20-265 hydroxy-terminated poly(oxypropylene)glycol, CAS No. 25322-69-4, a product of Arch Chemicals Inc.

¹⁰PolyG®HQEE hydroquinone di(beta-hydroxyethyl)ether CAS No. 104-38-1, a product of Arch Chemicals Inc.

¹¹HER-HP resorcinol di(beta-hydroxyethyl)ether CAS No. 102-40-9, a product of Indspec Chemical Corp.

### EXAMPLE 1

To a 3 L resin flask equipped with a stainless steel 3 blade agitator, Trubore bearing, thermocouple and a Firestone purge valve set up to vacuum and nitrogen the following ingredients were charged: 701.10 grams of an amorphous polyester ¹ (0.0700 eq.), 151.71 grams of a crystalline polyester² (0.0200 eq.) and 580.29 grams of a polylactone³ (0.7100 eq.). 128.26 grams of a secondary aromatic diamine⁴ (0.2000 eq.) and 12.15 grams of a antioxidant blend ⁵ were now added at room temperature. The resin flask was agitated while being heated and purged with dry nitrogen. The flask was heated to 110° C. under a vacuum of 0.01 mm and maintained under vacuum for 1 hour after being flushed several times with dry nitrogen through the use of the Firestone valve. After approximately 1 hour, the vacuum was relieved under N₂ and 672.85 grams of a diisocyanate⁶ (1.3000 eq.) were added as a melt. An immediate exotherm was observed with the reaction temperature increasing from 110° C. to 172° C. in a time period of 2 minutes. The vacuum was restarted and maintained at 0.50 mm for 1 hour at a temperature of 180° C. The vacuum was relieved under N₂ and a sample was taken for % NCO. 0.225 grams of a catalyst⁷ and 2.25 grams of a stabilizer⁸ were then added and the vacuum restarted. The % NCO was found to be 2.065 when titrated with 0.1 N HCl against a 0.1N n-dibutyl amine standard. The reaction was maintained at a temperature of 180° C. and a vacuum of 0.15 mm for an additional 45 minutes. The vacuum was relieved under N₂ and the viscous, translucent, yellow red liquid was poured into 3 Pam aluminum caulking tubes and 2 pint paint cans for later use. The viscosity was measured using a Brookfield viscometer equipped with a thermocell using a #27 spindle at 350° F. and found to be 17,900 cps.

### COMPARISON 2

To a 3 L resin flask equipped with a stainless steel 3 blade agitator, Trubore bearing, thermocouple and a Firestone purge valve set up to vacuum and nitrogen the following ingredients were charged: 673.93 grams of an amorphous polyester¹ (0.0700 eq.), 135.97 grams of a crystalline polyester² (0.0200 eq.) and 768.72 grams of a polyether⁹ (0.9100 eq.).12.15 grams of antioxidant blend⁵ were now added at room temperature. The resin was agitated while being heated and purged with dry nitrogen. The flask was heated to 120.1° C. under a vacuum of 0.5 mm and maintained under vacuum for 1 hour after being flushed several times with dry nitrogen through the use of a Firestone valve. After 1 hour, the vacuum was relieved under N₂ and 656.75 grams of a diisocyanate⁶ (1.3000 eq.) were added as a melt. An immediate exotherm was observed with the reaction temperature increasing from 113° C. to 161.7° C. in a time period of 17 minutes. The vacuum was restarted and maintained at 0.05 mm for 1 hour at a temperature of 162.3° C. The vacuum was relieved under N₂ and a sample was taken for % NCO. 0.225 grams of a catalyst⁷ and 2.25 grams of a stabilizer⁸ were then added and the vacuum restarted. The % NCO was found to be 1.950. The reaction was maintained at a temperature of 168.4° C. for an additional 45 minutes. The vacuum was relieved under N₂ and a viscous, clear liquid was poured into 6 Pam aluminum caulking tubes for later use. The viscosity was measured using a Brookfield viscometer equipped with a thermocell using a #27 spindle at 350° F. and found to be 8,800 cps.

### EXAMPLE 3

To a 3 L resin flask equipped with a stainless steel 3 blade agitator, Trubore bearing, thermocouple and a Firestone purge valve set up to vacuum and nitrogen the following ingredients were charged: 687.51 grams of an amorphous polyester ¹ (0.0700 eq.), 138.71 grams of a crystalline polyester ² (0.0200 eq.), and 611.85 grams of a polyether ⁹ (0.7100 eq.). The 138.71 grams of a secondary aromatic diamine ⁴ (0.2000 eq.), 12.15 grams of a antioxidant blend⁵ were now added at room temperature. The resin flask was agitated while being heated and purged with dry nitrogen. The flask was heated to 119.7° C. under a vacuum of 0.01 mm and maintained under vacuum for 1 hour after being flushed several times with dry nitrogen through the use of a Firestone valve. After 1 hour, the vacuum was relieved under N₂ and 611.85 grams of a diisocyanate⁶ (1.3000 eq.) were added as a melt. An immediate exotherm was observed with the reaction temperature increasing from 116.7 C to 172.0 C in a time period of 28 minutes. The vacuum was restarted and maintained at 0.05 mm for 1 hour at a temperature of 172.0 C. The vacuum was relieved under N₂ and a sample was taken for % NCO. 0.225 grams of a catalyst⁷ and 2.25 grams of a stabilizer⁸ were then added and the vacuum restarted. The % NCO was found to be 1.950. The reaction was maintained at a temperature of 172.0° C. for an additional 45 minutes. The vacuum was relieved under N₂ and a viscous, clear, yellow, liquid was poured into 6 Pam aluminum caulking tubes for later use. The viscosity was measured using a Brookfield viscometer equipped with a thermocell using a #27 spindle at 350° F. and found to be 10,000 cps.

### COMPARISON 4

To a 3 L resin flask equipped with a stainless steel 3 blade agitator, Trubore bearing, thermocouple and a Firestone purge valve set up to vacuum and nitrogen the following ingredients were charged: 694.29 grams of an amorphous polyester ¹ (0.0700 eq.), 137.46 grams of a crystalline polyester² (0.0200 eq.), and 740.64 grams of a polylactone ³ (0.09100 eq.). 12.15 grams of an antioxidant blend⁵ were now added at room temperature. The resin flask was agitated and purged while being heated and purged with dry nitrogen. The flask was heated to 120.5° C. under vacuum of 0.10 mm and maintained under a vacuum for 1 hour after being flushed several times with dry nitrogen through the use of the Firestone valve. After 1 hour, the vacuum was relieved under N₂ and 663.95 grams of a diisocyanate⁶ (1.3000 eq.) were added as a melt. An immediate exotherm was observed with the temperature increasing from 119° C. to 166.5° C. in a time period of 12 minutes. The vacuum was restarted and maintained at 0.20 mm for 1 hour at a temperature of 162.6° C. The vacuum was relieved under N₂ and a sample was taken for % NCO. 0.225 grams of a catalyst⁷ and 2.25 grams of a stabilizer⁸ were then added and the vacuum restarted. The % NCO was found to be 1.813. The reaction was maintained at a temperature of 173.7 C for additional 45 minutes. The vacuum was relieved under N₂ and the viscous, clear liquid was poured into 5 Pam aluminum tubes and one half pint can for later use. The viscosity was measured using a Brookfield viscometer equipped with a thermocell using a # 27 spindle at 350° F. and found to be 22,100 cps.

### EXAMPLE 5

To a 3 L resin flask equipped with a stainless steel 3 blade agitator, Trubore bearing, thermocouple and a Firestone purge valve set up to vacuum and nitrogen the following ingredients were charged: 623.20 grams of an amorphous polyester ¹ (0.0700 eq.), 215.93 grams of a crystalline polyester² (0.0200 eq.), 574.50 grams of a polylactone ³ (0.07100 eq.). The 28.53 grams of PolyG®HQEE¹⁰ (0.0700 eq.), 53.67 grams of HER-HP¹¹ (0.1300 eq.), and 12.15 grams of antioxidant blend⁵ were now added at room temperature. The resin flask was agitated while being heated and purged with dry nitrogen. The flask was heated to 125.3° C. under vacuum of 0.01 mm and maintained under a vacuum for 1 hour after being flushed several times with dry nitrogen through the use of the Firestone valve. After approximately 1 hour, the vacuum was relieved under N₂ and 660.08 grams of a diisocyanate⁶ (1.3000 eq.) were added as a melt. An immediate exotherm was observed with the temperature increasing from 117.8° C. to 168.0° C. in a time period of 11 minutes. The vacuum was restarted and maintained at 0.10 mm for 1 hour at a temperature of 181.0° C. The vacuum was relieved under N₂ and a sample was taken for % NCO. 0.225 grams of a catalyst⁷ and 2.25 grams of a stabilizer⁸ were then added and the vacuum restarted. The % NCO was found to be 1.981. The reaction was maintained at a temperature of 178.3° C. and a vacuum of 0.10 mm for an additional 45 minutes. The vacuum was relieved under N₂ and the viscous, opaque, white liquid was poured into 5 Pam aluminum caulking tubes for later use. The viscosity was measured using a Brookfield viscometer equipped with a thermocell using a H 27 spindle at 350° F. and found to be 26,950 cps.

TABLE 1

| | Ingredients/Measured | Examples and Comparisons | | | | |
|---|---|---|---|---|---|---|
| | Property | Example 1 | Comparison 2 | Example 3 | Comparison 4 | Example 5 |
| 1 | Rucoflex ™ XS-6012P-22 | 0.0700 | 0.0700 | 0.0700 | 0.0700 | 0.0700 |
| 2 | Rucoflex ™ S-1074-30 | 0.0200 | 0.0200 | 0.0200 | 0.0200 | 0.0200 |
| 3 | Capa ™ 2043 | 0.7100 | — | | 0.9100 | 0.7100 |
| 9 | PolyG ® 20-265 | — | 0.9100 | 0.7100 | — | — |
| 4 | Unilink ™ 4200 | 0.2000 | — | 0.2000 | — | — |
| 10 | PolyG ® HQEE | — | — | — | — | 0.0700 |
| 11 | HER - HP | — | — | — | — | 0.1300 |
| 5 | Irganox ™ B225 | 0.54% | 0.54% | 0.54% | 0.54% | 0.54% |
| 6 | Mondur ™ M | 1.3000 | 1.3000 | 1.3000 | 1.3000 | 1.3000 |
| 7 | Fomrez ™ UL-1 | 0.01% | 0.61% | 0.01% | 0.01% | 0.01% |
| 8 | PTSI | 0.1% | 0.1% | 0.1% | 0.1% | 0.1% |
| | % NCO (actual) | 2.065 | 1.950 | 1.995 | 1.813 | 1.981 |
| | Viscosity cps. @ 350° F. | 17,900 | 8,800 | 10,000 | 22,100 | 26,950 |
| | Creep (mm) | 1.75 | 10.0 | 2.25 | 13.25 | 3.50 |
| | 1 minute pli | 12.1 | 6.0 | 13.8 | 1.6 | 10.5 |
| | 5 minute pli | 19.6 | 12.5 | 19.6 | 9.7 | 16.5 |
| | Appearance of Melt | translucent | clear | clear | clear | white, |
| | | | | | | opaque |

All amounts are in equivalents except ingredients Nos. 5, 7 and 8 which are in % by weight, based on the
total weight of the adhesive composition.

| | |
|---|---|
| Example #1 | Formulation similar to Formulation according to Comparison 4 but with Unilink 4200. Note |
| | increase in strength and lower creep values over Comparison 4. |
| Comparison #2 | Formulation according to Henkel Pat. Nos. 5,599,895 & 6,136,136 |
| Example #3 | Formulation similar to Comparison 2 using a 400 molecular weight polyoxypropylene glycol |
| | and Unilink ™ 4200 aromatic secondary diamine. Note improvement in both strength and |
| | lower creep values. |
| Comparison #4 | Formulation similar to Comparison 2 and Example 3 without Unilink or Aromatic Diol but |
| | with CAPA diol. Note raise in creep value. |
| Example #5 | Formulation similar to Comparison 4 but with blend of Aromatic diol chain extenders. Note |
| | increase in strength and lower creep value. |

Green Strength Test: QC-0220

1.0 Scope:

This test method described below was used to determine the green strength of adhesives or primer/adhesive combinations as a function of time.

2.0 Definition of Terms:

1. Green Strength—The adhesion peel strength of an adhesive measured within a specified amount of time after the assembly of the bond.

2. Chlorination—The use of UPACO 3212 or 3213 on a rubber substrate chlorinates the rubber to allow adhesion.

3.0 Equipment/Materials:

1. Biltrite 6× gumtread #87 crinkle rubber soling (part#5522210621 available from QB Soling) cut into “1″×5″ strips

2. One Pam aluminium chalking tube used to retain of the adhesive to be tested.

3. UPACO 3213 2% Trichloroisocyanuric Acid (CAS#87-90-1) in ethyl acetate (CAS#141-78-6)

4. UPACO 3249 urethane primer-10% Thermoplastic polyurethane solution in solvent blend of acetone (CAS#67-64-1) methyl ethyl ketone (CAS#78-93-3) and toluene (CAS#108-88-3).

5. Stop watch capable of at least one-second accuracy

6. Rotary wire wheel rougher

7. Flash activator by Compo Industries or suitable equivalent.

8. Knight air activated Press.

9. USM “clicker” die press.

10. Scott shoe pull tester.

11. Acid brushes

12. 4 oz glass jar

13. Pam 500K hot melt application gun (available from Pam Fastening Technology Inc.

14. Desiccator filled with Drierite crystals, 8 mesh with indicator CaSO₄ (CAS#7778-18-9)

4.0 Procedure:

1. Cut the #87 crinkle rubber soling into 1″×5″ strips using the “clicker” and appropriate die

2. Using the rotary wheel rougher, rough (scour) the smooth side of the 1″×5″ strips of rubber to remove the outer layer of rubber, use compressed air to blow any loose particles off the strips.

3. Chlorinate the rubber strips by taking a new 4 oz glass jar, pour fresh UPACO 3213 into the jar, then re-seal the container of UPACO 3213. Using a new acid brush, coat the freshly roughed surface of the rubber strips with the UPACO 3213. Allow 15 minutes to dry.

4. Prime the strips with a new acid brush by coating the freshly chlorinated rubber strips with UPACO 3249 urethane primer. Allow 30 minutes to dry.

5. Primed strips prepared by steps 1-4 may be stored ahead of time for future use. Place in a plastic bag and mark the date of preparation and initial the bag.

6. Take 10 primed strips; mark the date made and initials on the formula

7. Pre-Heat the Pam 500K gun to the pre-set temperature of 375° F. Remove the purge cartridge, insert the adhesive retained in Pam aluminum caulking tube, but do not close gun for 15 minutes, then seal gun. Run gun until adhesive flows freely.

8. Coat the primed strips with the adhesive to be tested, target for a coating weight of approx 0.7 gms per strip. Allow 1″ of uncoated area on the top of each strip, and coat 5 strips total. Gather the strips into 5 pairs, one coated, one primed

9. Place the coated strips in a Desiccator containing Drierite crystals. Allow 30 minutes to cool the strips. The coated strips may be stored for up to 4 hours in the desiccator before testing.

10. Set the flash activator at 15 seconds and the press at 90 psi, and the dwell to 15 seconds, get the stopwatch set to count up in seconds. Press the foot pedal once to activate the unit before proceeding.

11. Take one strip coated with adhesive and one primed strip. Place the coated sample in the wire bin of the flash activator, adhesive side up, then place the primed strip, primer side up, next to it.

12. Press the foot pedal of the flash activator. When the bin reappears, quickly place the strips together, adhesive side to primer side, lining the pieces up as best possible.

13. Place the bond in the press and trigger the two buttons on the side simultaneously. Remove the bond when the press is finished, then start the stopwatch. Quickly proceed to the shoe lab and place the bond in the Scott tester.

14. Begin pulling the strip at 3″/min as marked on the speed control. While watching the stopwatch, record the dial reading at 1 minute. Stop the motor on the Scott tester and wait until 3 min 30 seconds on the stopwatch.

15. Start the motor again, while watching the stopwatch, record the dial reading at 5 minutes.

5.0 Evaluation:

1. Record each 1-minute and 5 minute reading for each strip on the batch sheet

2. Calculate the average of all 5 readings for both the 1-minute and 5-minute readings, then record the averages on the batch sheet.

3. Collect all the test strips and store them in a bag with the number and lot # of the adhesive tested.

Creep Test

1. Samples are prepared as described in the Green Strength Test: QC-220. Only five samples are prepared following Steps 1-8 under Procedure. These samples are allowed to condition at room temperature and ambient humidity for approximately 30 minutes.

2. Five additional samples are die cut 1″×5″ using the “clicker” and coded fabric designation “Brite White Profile 1” supplied by Majilite Corporation, Dracut, Mass. This is a polyurethane coated fabric.

3. Scotch Magic Tape 810, 1” wide is applied to one end of the 1″×5″ Profile to mask the end and trimmed so there is no overlap.

4. A small hole is punched in the center of the taped masked area.

5. The flash activator is set at 11 seconds and the press at 90 psi, and the dwell to 15 seconds. Press the foot pedal once to activate the unit before proceeding.

6. Take one coated sample and one masked and punched Profile strip and place them in the wire bin of the flash activator, adhesives side up and Profile side up.

7. Press the foot pedal of the flash activator. When the bin reappears, quickly place the strips together (activated sides together), lining the pieces up as best possible.

8. Place the bond in the press and trigger the two buttons on the side simultaneously. Remove the bond when the press is finished.

9. Separate the bonded sample at the taped end and mark the bond line with a colored pen. Suspend a 500 gram weight from the Profile punched hole.

10. Hang the sample with the weight in a horizontal plane such that the weight hangs down in a peel mode. Steps 9 through 10 should be complete within 30 seconds.

11. Allow the samples to hang in the undisturbed position for at least 30 minutes.

12. Remove the samples after the 30 minute dwell time. Mark the amount of creep using a colored pen.

13. Measure the distance between the two colored pen lines and report the value in millimeters.

14. Report the average of four determinations for each adhesive tested.

While the invention has been described above with reference to specific embodiments thereof, it is apparent that many changes, modifications, and variations can be made without departing from the inventive concept disclosed herein. Accordingly, it is intended to embrace all such changes, modifications and variations that fall within the spirit and broad scope of the appended claims. All patent applications, patents and other publications cited herein are incorporated by reference in their entirety.

1. An uncured, moisture-curing, hot-melt polyurethane adhesive composition, the composition having an aromatic chain extender component, the adhesive composition exhibiting a green peel strength of at least 5 pounds per linear inch at 1 minute and at least 12 pounds per linear inch at 5 minutes, when measured in accordance with Test QC-0220, and a creep resistance of less than 7 millimeters, when measured in accordance with Creep Test.

2. The adhesive composition of claim 1 wherein the aromatic chain extender is selected from the group consisting of ethoxylated diols, propoxylated diols, ethoxylated/propoxylated diols, ethoxylated bisphenyl A, propoxylated bisphenol A, ethoxylated bisphenol F, propoxylated bisphenol F, derivatives of ethoxylated bisphenol A and propoxylated bisphenol A, derivatives of ethoxylated bisphenol F, propoxylated bisphenol F, hindered aromatic diamines and secondary aromatic diamines.

3. The composition of claim 2 wherein the aromatic chain extender is secondary aromatic diamine.

4. The composition of claim 2 wherein the aromatic chain extender is the bis-(hydroxyethyl)ether of hydroquinone [HQEE].

5. The composition of claim 2 wherein the aromatic chain extender is the bis-(hydroxyethyl)ether of resorcinol [HER-HP].

6. A moisture-curing hot-melt polyurethane adhesive composition, the composition being the reaction product reactants comprising:
a hydroxyl-containing component selected from the group consisting of one or more polylactones, one or more polyether polyols, or combinations thereof in an amount within the range of between about 50% to 10% by weight;
an aromatic chain extender in an amount within the range of between about 15% to 1% by weight;
a crystalline polyester in an amount within the range of between about 30% to 5% by weight;
an amorphous polyester in an amount within the range of between about 50% to 10% by weight; and
an isocyanate present in an amount within the range of between about 40% to 10% by weight, based on the total weight of the composition, the adhesive composition exhibiting a green peel strength of at least 5 pli @ 1 minute and 12 pli @ 5 minutes when tested in accordance with QC-0220.

7. The adhesive composition of claim 6 wherein the polylactone is a low molecular weight polylactone.

8. The adhesive composition of claim 7 wherein the aromatic chain extender is selected from the group consisting of ethoxylated diols, propoxylated diols, ethoxylated/propoxylated diols, ethoxylated bisphenol A, propoxylated bisphenol A, ethoxylated bisphenol F, propoxylated bisphenol F, derivatives of ethoxylated bisphenol A and propoxylated bisphenol A, derivatives of ethoxylated bisphenol F, propoxylated bisphenol F, hindered aromatic diamines and secondary aromatic diamines.

9. The adhesive composition of claim 8 wherein the polyisocyanate is selected from the group consisting of aromatic polyisocyanate, 4,4′-diphenylmethane diisocyanate, 2.4′-diphenylmethane diisocyanate and mixtures, toluene diisocyanate and aliphatic and cycloaliphatic polyisocyanates.

10. The adhesive composition of claim 7 wherein the polylactone is a caprolactone.

11. A moisture-curing hot-melt polyurethane adhesive, the adhesive being the reaction product of the reactants comprising:
a low molecular weight caprolactone in an amount of 25.0% weight;
a crystalline polyester in an amount of 15.0% weight;
an amorphous polyester in an amount of 25.0% weight;
a secondary aromatic diamine in an amount of 5.0% weight; and
an isocyanate present in the adhesive composition in an amount of 30.0% weight, based on the total weight of the adhesive composition.

12. The adhesive composition of claim 11 wherein the secondary aromatic diamine is 4, 4′ bis(sec-butylamino)-diphenylmethane.

13. A method of producing a moisture-curing hot-melt polyurethane adhesive composition comprising:
heating a hydroxyl-containing component selected from the group consisting of one or more polylactones, one or more polyether polyols, or combinations thereof; a crystalline polyester; an amorphous polyester; and an aromatic chain extender to form a mixture;
and reacting a polyisocyanate with the mixture to produce the adhesive composition, the adhesive composition exhibiting a green peel strength of at least 5 pli @ 1 minute and at least 12 pli @ 5 minutes when tested in accordance with QC-0220.

14. The method according to claim 13 wherein heating comprises admixing the hydroxyl-containing compound in an amount of from about 50.0% by weight to about 10.0% by weight; the aromatic chain extender in an amount of from about 1.0% by weight to about 15.0% by weight; the crystalline polyester in an amount of from about 30.0% by weight to about 5.0% by weight; and the amorphous polyester in an amount of from about 50.0% by weight to about 10.0% by weight and reacting the isocyanate in an amount from about 40% by weight to about 10% by weight with the mixture, the weights being based on the total weight of the adhesive composition.

15. A method for bonding a first substrate to a second substrate comprising:
optionally, treating at least a portion of the first substrate to form a treated substrate;
heating an adhesive composition, the composition being the reaction product of reactants comprising:
a polylactone in an amount within the range of between about 1% to 50% by weight;
an aromatic chain extender in an amount within the range of between about 1.0% to 15% by weight;
a crystalline polyester in an amount within the range of between about 30% to 5% by weight;
an amorphous polyester in an amount within the range of between about 50% to 10% by weight; and
an isocyanate in an amount within the range of between about 40% to 10% by weight, based on the total weight of the composition, the adhesive composition exhibiting a green peel strength of at least 5 pli @ 1 minute and 12 pli @ 5 minutes when tested in accordance with QC-0220, to form a molten adhesive;
coating at least a portion of the treated substrate with the molten adhesive to form a coated substrate;
optionally, heating the coated substrate; and
contacting the coated substrate with the second substrate to bond the first substrate to the second substrate.

16. The method according to claim 15 wherein treating is roughing, priming, chlorinating or solvent washing.

17. The method according to claim 16 wherein contacting is pressing.

18. The method of claim 17 wherein the first substrate is leather or synthetic fabric.

19. The method of claim 18 wherein the second substrate is leather or natural or synthetic rubber.

20. The method of claim 17 wherein the first substrate is a shoe upper.

21. The method of claim 17 wherein the second substrate is a shoe sole.

22. A moisture-curing hot-melt polyurethane adhesive composition, the composition being the reaction product of reactants comprising:
a low molecular weight caprolactone in an amount of 25% weight;
a crystalline polyester present in an amount of 6.0% weight;
an amorphous polyester present in an amount of 33.0% weight;
an aromatic chain extender present in an amount of 6.0% weight; and
a diisocyanate present in an amount of 30.0% weight, all weights based on the total weight of the adhesive composition.

23. A moisture-curing hot-melt polyurethane adhesive composition, the composition being the reaction product reactants comprising:
a polyether in an amount within the range of between about 50% to 10% by weight;
an aromatic chain extender in an amount within the range of between about 15.0% to 1.0% by weight;
a crystalline polyester in an amount within the range of between about 30% to 5% by weight;
an amorphous polyester in an amount within the range of between about 50% to 10% by weight; and
an isocyanate present in an amount within the range of between about 40% to 10% by weight; all weights based on the total weight of the composition, the adhesive composition exhibiting a green peel strength of at least 5 pli @ 1 minute and 12 pli @ 5 minutes when tested in accordance with QC-0220.

24. The adhesive composition of claim 23 wherein the polyether is selected from the group consisting of polyethylene glycol, polytetramethylene glycol, poly (oxypropylene) glycol and polypropylene glycol.

25. The adhesive composition of claim 23 wherein the aromatic chain extender is a secondary aromatic diamine.

26. An article of manufacture comprising a shoe upper and a shoe sole bonded together with an adhesive comprising the composition of claim 1.

27. An article of manufacture comprising a shoe upper and a shoe sole bonded together with an adhesive comprising the composition of claim 6.
